(19) United States
(12) Patent Application Publication
(10) Pub. No.: US 2015/0253943 A1
(43) Pub. Date: Sep. 10, 2015

(54) Method and Apparatus for Implementing Remote Browsing

(71) Applicant: Huawei Technologies Co., Ltd., Shenzhen (CN)

(72) Inventor: Mingxing Yu, Nanjing (CN)

(21) Appl. No.: 14/719,640

(22) Filed: May 22, 2015

Related U.S. Application Data
(63) Continuation of application No. PCT/CN2012/085165, filed on Nov. 23, 2012.

(51) Int. Cl. G06F 3/0483; G06F 3/0488; G06F 3/0482; H04L 29/08; G06F 3/0484; G06F 3/0485

(52) U.S. Cl. CPC G06F 3/0483; G06F 3/04842; G06F 3/04855; G06F 3/0482; H04L 67/02; G06F 3/0488

(57) ABSTRACT

The present invention discloses a method and an apparatus for implementing remote browsing, relates to the field of terminal technologies, and implements that a user fast and accurately browses content with a scroll bar. The present invention includes: when it is detected that an operation behavior of a user on a touchscreen meets a preset manner, acquiring a motion characteristic parameter of the operation behavior; determining whether the motion characteristic parameter exceeds a threshold; when it is determined that the motion characteristic parameter does not exceed the threshold, instructing a server to perform a page scrolling operation; and when it is determined that the motion characteristic parameter exceeds the threshold, instructing, according to a preset page flipping rule, the server to perform a page flipping operation of a page.

This application is a continuation of International Patent Application No. PCT/CN2012/085165, filed on Nov. 23, 2012, which is hereby incorporated by reference in its entirety.

### TECHNICAL FIELD

The present invention relates to the field of terminal technologies, and in particular, to a method and an apparatus for implementing remote browsing.

### BACKGROUND

Touchscreen devices (such as a tablet computer and a smartphone) have become increasingly popular, and at the same time, a large number of personal computer (PC) also exist. The former are light and convenient, and feature convenient gesture operation experience, but are incomplete in performance, functions, application, and the like; and the latter depend on mouse devices and keyboards for input, and feature strong performance, comprehensive functions, a large number of applications, and abundant bandwidth. A user has a requirement for combining advantages of the both. An existing solution is to use a touchscreen device to remotely connect to and operate a PC, to enable the touchscreen device to directly experience advantages of the PC.

In this solution, the user may send various operation instruction messages to a server PC by using a touchscreen of a client, to instruct the server PC to perform corresponding operations. For example, the user performs a tap operation on the touchscreen of the client; when capturing a tap message, the client sends a mouse click message to the server PC, and when capturing a key-press event, the client sends a key-press message to the server.

When the user uses the touchscreen of the client to remotely browse content with a scroll bar (a document, a webpage, an application, and the like), and particularly when the content is very long, the content may be divided into many pages. Because a specification of the touchscreen of the client is limited, all or some content displayed on a remote PC can be displayed on the touchscreen of the client only after content displayed on the server is reduced according to a proportion, and consequently the scroll bar is reduced or deformed correspondingly. In this case, if the user wants to use the touchscreen of the client to read up and down carefully by one line or several lines or read by horizontal dragging; or wants to quickly flip pages to a page to browse as quickly as possible, the user cannot accurately tap the scroll bar because the scroll bar has been reduced or deformed, so that the user cannot implement fast page flipping, or the user can tap the scroll bar but it is difficult to control the scroll bar to perform relatively small displacement. As a result, the user cannot read up and down carefully by one line or several lines.

### SUMMARY

Embodiments of the present invention provide a method and an apparatus for implementing remote browsing, which implements that a user fast and accurately browses content with a scroll bar.

To achieve the foregoing objective, the following technical solutions are used in the embodiments of the present invention:

According to a first aspect, an embodiment of the present invention provides a method for implementing remote browsing, including:

when it is detected that an operation behavior of a user on a touchscreen meets a preset manner, acquiring a motion characteristic parameter of the operation behavior;

determining whether the motion characteristic parameter exceeds a threshold;

when it is determined that the motion characteristic parameter does not exceed the threshold, instructing a server to perform a page scrolling operation; and

when it is determined that the motion characteristic parameter exceeds the threshold, instructing, according to a preset page flipping rule, the server to perform a page flipping operation of a page.

In a first possible implementation manner of the first aspect, the motion characteristic parameter is any one of the following parameters:

a principal axis displacement amount, where a principal axis is a lateral axis or a longitudinal axis of the touchscreen, and the principal axis displacement amount is used to indicate a displacement amount of the operation behavior on the principal axis;

a principal axis displacement speed, where the principal axis displacement speed is used to indicate a displacement speed of the operation behavior in a direction of the principal axis; and

a position changing speed, where the position changing speed is used to indicate a speed at which a position of a touch point between the user and the touchscreen in the operation behavior is changed.

With reference to the first possible implementation manner of the first aspect, in a second possible implementation manner, when the motion characteristic parameter includes the principal axis displacement amount, the determining whether the motion characteristic parameter exceeds a threshold includes:

determining whether the principal axis displacement amount is greater than a displacement threshold;

when it is determined that the principal axis displacement amount is greater than the displacement threshold, determining that the motion characteristic parameter exceeds the threshold; and

when it is determined that the principal axis displacement amount is not greater than the displacement threshold, determining that the motion characteristic parameter does not exceed the threshold.

With reference to the first possible implementation manner of the first aspect, in a third possible implementation manner, when the motion characteristic parameter includes the principal axis displacement speed, the determining whether the motion characteristic parameter exceeds a threshold includes:

determining whether the principal axis displacement speed is greater than a displacement speed threshold;

when it is determined that the principal axis displacement speed is greater than the displacement speed threshold, determining that the motion characteristic parameter exceeds the threshold; and

when it is determined that the principal axis displacement speed is not greater than the displacement speed threshold, determining that the motion characteristic parameter does not exceed the threshold.

With reference to the first possible implementation manner of the first aspect, in a fourth possible implementation manner, when the motion characteristic parameter includes the position changing speed, the determining whether the motion characteristic parameter exceeds a threshold includes:

determining whether the position changing speed is greater than a position changing speed threshold;

when it is determined that the position changing speed is greater than the position changing speed threshold, determining that the motion characteristic parameter exceeds the threshold; and

when it is determined that the position changing speed is not greater than the position changing speed threshold, determining that the motion characteristic parameter does not exceed the threshold.

With reference to the first aspect and the first four possible implementation manners of the first aspect, in a fifth possible implementation manner, the instructing a server to perform a page scrolling operation includes:

acquiring a scrolling direction of the operation behavior on the principal axis, and determining a current page scrolling direction according to the scrolling direction of the page on the principal axis;

determining a scrolling displacement amount of the page principal axis according to the principal axis displacement amount; and

sending the current page scrolling direction and the scrolling displacement amount of the page principal axis to the server, so that the server scrolls a currently displayed page according to the current page scrolling direction and the scrolling displacement amount of the page principal axis.

With reference to the first aspect and the first four possible implementation manners of the first aspect, in a sixth possible implementation manner, the instructing a server to perform a page scrolling operation includes:

determining a current page scrolling direction according to the principal axis displacement amount and an auxiliary axis displacement amount, where the auxiliary axis is the longitudinal axis or the lateral axis of the touchscreen, and is different from the principal axis;

when it is determined that the current page scrolling direction is scrolling on the principal axis, determining a scrolling displacement amount of the page principal axis according to the principal axis displacement amount, and sending the scrolling direction of the page on the principal axis and the scrolling displacement amount of the page principal axis to the server, so that the server scrolls a currently displayed page according to the scrolling direction of the page on the principal axis and the scrolling displacement amount of the page principal axis;

when it is determined that the current page scrolling direction is scrolling on the auxiliary axis, determining a scrolling displacement amount of the page auxiliary axis according to the auxiliary axis displacement amount, and sending the scrolling direction of the page on the auxiliary axis and the scrolling displacement amount of the page auxiliary axis to the server, so that the server scrolls the currently displayed page according to the scrolling direction of the page on the auxiliary axis and the scrolling displacement amount of the page auxiliary axis; and

when it is determined that the current page scrolling direction is neither on the principal axis nor on the auxiliary axis, determining the scrolling displacement amount of the page principal axis according to the principal axis displacement amount, determining the scrolling displacement amount of the page auxiliary axis according to the auxiliary axis displacement amount, and sending a scrolling direction of the page on the principal axis, the scrolling displacement amount of the page principal axis, a scrolling direction on the auxiliary axis, and the scrolling displacement amount of the page auxiliary axis to the server, so that the server scrolls the currently displayed page according to the scrolling direction of the page on the principal axis, the scrolling displacement amount of the page principal axis, the scrolling direction on the auxiliary axis, and the scrolling displacement amount of the page auxiliary axis.

With reference to the first six possible implementation manners of the first aspect, in a seventh possible implementation manner, the determining a current page scrolling direction according to the principal axis displacement amount and an auxiliary axis displacement amount includes:

when a ratio of the principal axis displacement amount to the auxiliary axis displacement amount is less than a first direction threshold, determining that the page scrolls in a direction of the auxiliary axis;

when the ratio of the principal axis displacement amount to the auxiliary axis displacement amount is greater than a second direction threshold, determining that the page scrolls in a direction of the principal axis; and

when the ratio of the principal axis displacement amount to the auxiliary axis displacement amount is neither greater than the second direction threshold nor less than the first direction threshold, determining that the current page scrolling direction is neither on the principal axis nor on the auxiliary axis.

With reference to the first aspect and the first four possible implementation manners of the first aspect, in an eighth possible implementation manner, the instructing, according to a preset page flipping rule, the server to perform a page flipping operation of a page includes:

acquiring a scrolling direction of the page on the principal axis;

determining a page flipping direction according to the scrolling direction of the page on the principal axis; and

sending the page flipping direction to the server, so that the server adjusts a currently displayed page according to the page flipping direction.

With reference to the first aspect and the first four possible implementation manners of the first aspect, in a ninth possible implementation manner, the instructing, according to a preset page flipping rule, the server to perform a page flipping operation of a page includes:

sending scroll bar position request information to the server;

receiving a server scroll bar position that is sent by the server in response to the scroll bar position request information;

displaying a scroll bar of a preset specification on the touchscreen according to the current server scroll bar position;

acquiring a scroll bar displacement amount and a direction that are generated when the user uses the scroll bar of a preset specification; and

sending, to the server, the scroll bar displacement amount and the direction that are generated when the user uses the scroll bar of a preset specification, so that the server adjusts a currently displayed page and the server scroll bar position according to the scroll bar displacement amount and the direction that are generated when the user uses the scroll bar of a preset specification.

With reference to the first aspect and the first four possible implementation manners of the first aspect, in a tenth possible implementation manner, the instructing, according to a preset page flipping rule, the server to perform a page flipping operation of a page includes:

displaying a preset function key on the touchscreen, where the preset function key includes a Page Up key and a Page Down key; and

when it is detected that the user taps the preset function key, sending a notification message corresponding to the preset function key tapped by the user to the server, so that the server adjusts a currently displayed page according to the notification message corresponding to the preset function key tapped by the user.

According to a second aspect, an embodiment of the present invention provides an apparatus for implementing remote browsing, including:

an acquiring unit, configured to, when it is detected that an operation behavior of a user on a touchscreen meets a preset manner, acquire a motion characteristic parameter of the operation behavior;

a determining unit, configured to determine whether the motion characteristic parameter acquired by the acquiring unit exceeds a threshold; and

a notification unit, configured to: when the determining unit determines that the motion characteristic parameter does not exceed the threshold, instruct a server to perform a page scrolling operation; and when the determining unit determines that the motion characteristic parameter exceeds the threshold, instruct, according to a preset page flipping rule, the server to perform a page flipping operation of a page.

In a first possible implementation manner of the second aspect, the motion characteristic parameter is any one of the following parameters:

a principal axis displacement amount, where a principal axis is a lateral axis or a longitudinal axis of the touchscreen, and the principal axis displacement amount is used to indicate a displacement amount of the operation behavior on the principal axis;

a principal axis displacement speed, where the principal axis displacement speed is used to indicate a displacement speed of the operation behavior in a direction of the principal axis; and

a position changing speed, where the position changing speed is used to indicate a speed at which a position of a touch point between the user and the touchscreen in the operation behavior is changed.

With reference to the first possible implementation manner of the second aspect, in a second possible implementation manner, the determining unit is specifically configured to: when the motion characteristic parameter includes the principal axis displacement amount, determine whether the principal axis displacement amount is greater than a displacement threshold; when it is determined that the principal axis displacement amount is greater than the displacement threshold, determine that the motion characteristic parameter exceeds the threshold; and when it is determined that the principal axis displacement amount is not greater than the displacement threshold, determine that the motion characteristic parameter does not exceed the threshold.

With reference to the first possible implementation manner of the second aspect, in a third possible implementation manner, the determining unit is specifically configured to: when the motion characteristic parameter includes the principal axis displacement speed, determine whether the principal axis displacement speed is greater than a displacement speed threshold; when it is determined that the principal axis displacement speed is greater than the displacement speed threshold, determine that the motion characteristic parameter exceeds the threshold; and when it is determined that the principal axis displacement speed is not greater than the displacement speed threshold, determine that the motion characteristic parameter does not exceed the threshold.

With reference to the first possible implementation manner of the second aspect, in a fourth possible implementation manner, the determining unit is specifically configured to: when the motion characteristic parameter includes the position changing speed, determine whether the position changing speed is greater than a position changing speed threshold; when it is determined that the position changing speed is greater than the position changing speed threshold, determine that the motion characteristic parameter exceeds the threshold; and when it is determined that the position changing speed is not greater than the position changing speed threshold, determine that the motion characteristic parameter does not exceed the threshold.

With reference to the second aspect and the first four possible implementation manners of the second aspect, in a fifth possible implementation manner, the notification unit includes:

a first acquiring module, configured to acquire a scrolling direction of the operation behavior on the principal axis;

a first determining module, configured to: determine a current page scrolling direction according to the scrolling direction of the page on the principal axis acquired by the first acquiring module; and determine a scrolling displacement amount of the page principal axis according to the principal axis displacement amount; and

a first sending module, configured to send, to the server, the current page scrolling direction and the scrolling displacement amount of the page principal axis that are determined by the first determining module, so that the server scrolls a currently displayed page according to the current page scrolling direction and the scrolling displacement amount of the page principal axis.

With reference to the second aspect and the first four possible implementation manners of the second aspect, in a sixth possible implementation manner, the notification unit includes:

a second determining module, configured to determine a current page scrolling direction according to the principal axis displacement amount and an auxiliary axis displacement amount, where the auxiliary axis is the longitudinal axis or the lateral axis of the touchscreen, and is different from the principal axis;

a third determining module, configured to: when it is determined that the current page scrolling direction is scrolling on the principal axis, determine a scrolling displacement amount of the page principal axis according to the principal axis displacement amount; when it is determined that the current page scrolling direction is scrolling on the auxiliary axis, determine a scrolling displacement amount of the page auxiliary axis according to the auxiliary axis displacement amount; and when it is determined that the current page scrolling direction is neither on the principal axis nor on the auxiliary axis, determine the scrolling displacement amount of the page principal axis according to the principal axis displacement amount, and determine the scrolling displacement amount of the page auxiliary axis according to the auxiliary axis displacement amount; and

a second sending module, configured to: send the scrolling direction of the page on the principal axis and the scrolling displacement amount of the page principal axis to the server, so that the server scrolls a currently displayed page according to the scrolling direction of the page on the principal axis and the scrolling displacement amount of the page principal axis; send the scrolling direction of the page on the auxiliary axis and the scrolling displacement amount of the page auxiliary axis to the server, so that the server scrolls the currently displayed page according to the scrolling direction of the page on the auxiliary axis and the scrolling displacement amount of the page auxiliary axis; and send a scrolling direction of the page on the principal axis, the scrolling displacement amount of the page principal axis, a scrolling direction on the auxiliary axis, and the scrolling displacement amount of the page auxiliary axis to the server, so that the server scrolls the currently displayed page according to the scrolling direction of the page on the principal axis, the scrolling displacement amount of the page principal axis, the scrolling direction on the auxiliary axis, and the scrolling displacement amount of the page auxiliary axis.

With reference to the first six possible implementation manners of the second aspect, in a seventh possible implementation manner, the second determining module is specifically configured to: when a ratio of the principal axis displacement amount to the auxiliary axis displacement amount is less than a first direction threshold, determine that the page scrolls in a direction of the auxiliary axis; when the ratio of the principal axis displacement amount to the auxiliary axis displacement amount is greater than a second direction threshold, determine that the page scrolls in a direction of the principal axis; and when the ratio of the principal axis displacement amount to the auxiliary axis displacement amount is neither greater than the second direction threshold nor less than the first direction threshold, determine that the current page scrolling direction is neither on the principal axis nor on the auxiliary axis.

With reference to the second aspect and the first four possible implementation manners of the second aspect, in an eighth possible implementation manner, the notification unit further includes:

a second acquiring module, configured to acquire a scrolling direction of the page on the principal axis;

a fourth determining module, configured to determine a page flipping direction according to the scrolling direction of the page on the principal axis acquired by the second acquiring module; and

a third sending module, configured to send the page flipping direction to the server, so that the server adjusts currently displayed content according to the page flipping direction, and returns an adjustment result to the touchscreen for display.

With reference to the second aspect and the first four possible implementation manners of the second aspect, in a ninth possible implementation manner, the notification unit includes:

a fourth sending module, configured to send scroll bar position request information to the server;

a receiving module, configured to receive a server scroll bar position that is sent by the server in response to the scroll bar position request information;

a first display module, configured to display a scroll bar of a preset specification on the touchscreen according to the current server scroll bar position received by the receiving module;

an acquiring module, configured to acquire a scroll bar displacement amount and a direction that are generated when the user uses the scroll bar of a preset specification; and

a fifth sending module, configured to send, to the server, the scroll bar displacement amount and the direction that are generated when the user uses the scroll bar of a preset specification and are acquired by the acquiring module, so that the server adjusts a currently displayed page and the server scroll bar position according to the scroll bar displacement amount and the direction that are generated when the user uses the scroll bar of a preset specification.

With reference to the second aspect and the first four possible implementation manners of the second aspect, in a tenth possible implementation manner, the notification unit includes:

a second display module, configured to display a preset function key on the touchscreen, where the preset function key includes a Page Up key and a Page Down key; and

a sixth sending module, configured to, when it is detected that the user taps the preset function key, send a notification message corresponding to the preset function key tapped by the user to the server, so that the server adjusts a currently displayed page according to the notification message corresponding to the preset function key tapped by the user.

In the method and the apparatus for implementing remote browsing provided by the embodiments of the present invention, an intention, of a user, of determining page scrolling and page flipping is determined by using a motion characteristic parameter corresponding to an operation behavior of the user on a touchscreen, so that the user can implement adjustment of page display content by using an operation in any position of the touchscreen, and the user may perform a corresponding operation according to the intention of the user, so as to implement fast page flipping or merely make relatively small displacement of a page. Compared with the prior art in which only a reduced or deformed scroll bar can be used, the embodiments of the present invention can implement that the user fast and accurately browses content with a scroll bar.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for implementing remote browsing according to an embodiment of the present invention;

FIG. 2 is a flowchart of another method for implementing remote browsing according to an embodiment of the present invention;

FIG. 3 is a flowchart of another method for implementing remote browsing according to an embodiment of the present invention;

FIG. 4 is a flowchart of another method for implementing remote browsing according to an embodiment of the present invention;

FIG. 5 is a flowchart of another method for implementing remote browsing according to an embodiment of the present invention;

FIG. 6 is a flowchart of another method for implementing remote browsing according to an embodiment of the present invention;

FIG. 7 is a flowchart of another method for implementing remote browsing according to an embodiment of the present invention;

FIG. 8 is a flowchart of another method for implementing remote browsing according to an embodiment of the present invention;

FIG. 9 is a flowchart of another method for implementing remote browsing according to an embodiment of the present invention;

FIG. 10 is a flowchart of another method for implementing remote browsing according to an embodiment of the present invention;

FIG. 11 is a composition block diagram of an apparatus for implementing remote browsing according to an embodiment of the present invention;

FIG. 12 is a composition block diagram of another apparatus for implementing remote browsing according to an embodiment of the present invention;

FIG. 13 is a composition block diagram of another apparatus for implementing remote browsing according to an embodiment of the present invention;

FIG. 14 is a composition block diagram of another apparatus for implementing remote browsing according to an embodiment of the present invention;

FIG. 15 is a composition block diagram of another apparatus for implementing remote browsing according to an embodiment of the present invention;

FIG. 16 is a composition block diagram of another apparatus for implementing remote browsing according to an embodiment of the present invention; and

FIG. 17 is a composition block diagram of another apparatus for implementing remote browsing according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An embodiment of the present invention provides a method for implementing remote browsing, and the method may be applied to application scenarios such as remote login and remote office. In these application scenarios, a user uses a client to implement browsing of content, such as a page and a document, on a server. The client includes a device that has touchscreen hardware and corresponding software support, for example, a smartphone and a tablet computer. The server may include various devices that include a PC and can be remotely logged in to.

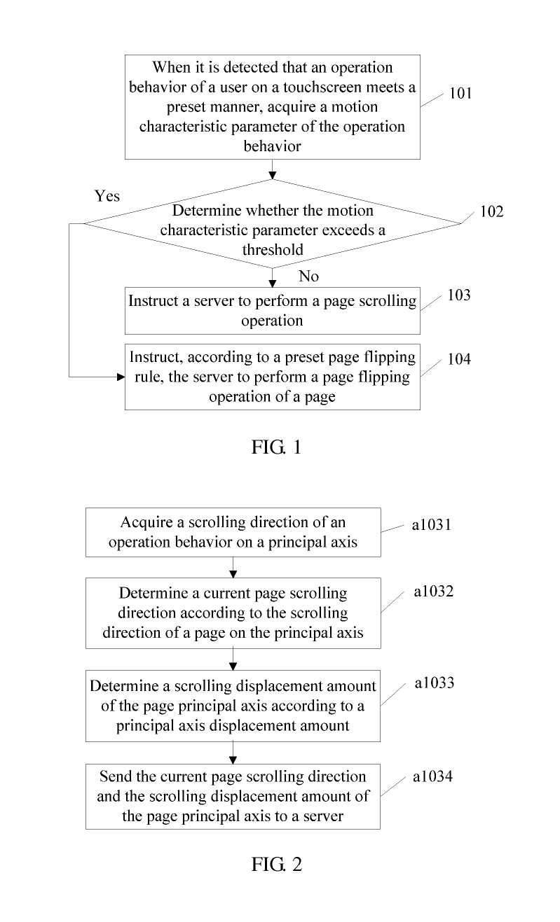

Based on the foregoing scenario description, as shown in FIG. 1, a method for implementing remote browsing provided by this embodiment of the present invention is implemented by the client, and includes:

101: When it is detected that an operation behavior of a user on a touchscreen meets a preset manner, acquire a motion characteristic parameter of the operation behavior.

The preset manner is used to represent an operation behavior that a user intends to scroll a page or flip a page, and may be preset on the client by a developer, or may be customized and set on the client by the user. For example, that the user uses one or two fingers to simultaneously press and drag down and finally lifts the two fingers simultaneously may be set as an operation behavior used when the user intends to implement page scrolling or page flipping; and that the user uses a stylus to press and drag down and then lifts the stylus may also be set as the operation behavior used when the user intends to implement page scrolling or page flipping. Certainly, this is only an example, and any operation manner that can be implemented by people may be set as the preset manner on the client.

For the foregoing method for detecting the operation behavior of the user on the touchscreen, a device that has touchscreen hardware and corresponding software may provide corresponding functions. In this embodiment, it may be directly detected, in combination with these functions, whether the operation behavior of the user on the touchscreen meets the preset manner.

102: Determine whether the motion characteristic parameter exceeds a threshold; when it is determined that the motion characteristic parameter does not exceed the threshold, step 103 is executed; and otherwise, step 104 is executed.

The motion characteristic parameter is any one of the following parameters:

a principal axis displacement amount, where a principal axis is a lateral axis or a longitudinal axis of the touchscreen, and the principal axis displacement amount is used to indicate a displacement amount of the operation behavior on the principal axis;

a principal axis displacement speed, where the principal axis displacement speed is used to indicate a displacement speed of the operation behavior in a direction of the principal axis; and

a position changing speed, where the position changing speed is used to indicate a speed at which a position of a touch point between the user and the touchscreen in the operation behavior is changed.

Corresponding to different motion characteristic parameters, corresponding thresholds are also set correspondingly in this embodiment of the present invention, where the thresholds include:

a displacement threshold that corresponds to the principal axis displacement amount and may be set to 100 pixels, 150 pixels, 200 pixels, or the like;

a displacement speed threshold that corresponds to the principal axis displacement speed and may be set to 100 pixels/ms, that is, moving 100 pixels per ms, or may be set to 150 pixels/ms, 200 pixels/ms, or the like; and

a position changing speed threshold that corresponds to the position changing speed and may be set to 10/100 ms, that is, the position of the touch point between the user and the touchscreen is changed 10 times per 100 ms, or may be set to 15/100 ms, 20/150 ms, or the like.

It should be noted herein that both the lateral axis and the longitudinal axis of the touchscreen may use configurations preset by hardware and software of the touchscreen, and certainly, the configurations may also be manually reset. In this embodiment, the principal axis and an auxiliary axis respectively correspond to either of the lateral axis and the longitudinal axis of the touchscreen; and a correspondence thereof may be preset, or displacement in directions of the lateral axis and the longitudinal axis may be compared, so as to determine that an axis with more displacement is the principal axis and the other axis is the auxiliary axis.

103: Instruct a server to perform a page scrolling operation, and end the procedure.

104: Instruct, according to a preset page flipping rule, the server to perform a page flipping operation of a page, and end the procedure.

In the method for implementing remote browsing provided by this embodiment of the present invention, an intention, of a user, of determining page scrolling and page flipping is determined by using a motion characteristic parameter corresponding to an operation behavior of the user on a touchscreen, so that the user can implement adjustment of page display content by using an operation in any position of the touchscreen, and the user may perform a corresponding operation according to the intention of the user, so as to implement fast page flipping or merely make relatively small displacement of a page. Compared with the prior art in which only a reduced or deformed scroll bar can be used, this embodiment of the present invention can implement that the user fast and accurately browses content with a scroll bar.

With reference to the method for implementing remote browsing shown in FIG. 1, for implementation of determining whether the motion characteristic parameter exceeds the threshold in step 102, this embodiment of the present invention further provides the following three methods, which are specifically:

The first method: Determine whether the principal axis displacement amount is greater than the displacement threshold; when it is determined that the principal axis displacement amount is greater than the displacement threshold, determine that the motion characteristic parameter exceeds the threshold; and when it is determined that the principal axis displacement amount is not greater than the displacement threshold, determine that the motion characteristic parameter does not exceed the threshold.

The second method: Determine whether the principal axis displacement speed is greater than the displacement speed threshold; when it is determined that the principal axis displacement speed is greater than the displacement speed threshold, determine that the motion characteristic parameter exceeds the threshold; and when it is determined that the principal axis displacement speed is not greater than the displacement speed threshold, determine that the motion characteristic parameter does not exceed the threshold.

The third method: Determine whether the position changing speed is greater than the position changing speed threshold; when it is determined that the position changing speed is greater than the position changing speed threshold, determine that the motion characteristic parameter exceeds the threshold; and when it is determined that the position changing speed is not greater than the position changing speed threshold, determine that the motion characteristic parameter does not exceed the threshold.

In the first method, the principal axis displacement amount may be acquired by a touchscreen hardware device and related software.

In the second method, the principal axis displacement speed may be obtained by calculation according to the principal axis displacement amount and movement time of the operation behavior, that is, Principal axis displacement speed=Principal axis displacement amount/Movement time.

In the third method, because a position capturing method provided on the touchscreen is periodical, that is, a current touch point position is detected once at intervals of fixed duration, it may be determined that the touch point position moves if positions of two measurements are different. By using this characteristic, if the fixed duration is 5 ms, the position may be measured for 20 times within 100 ms, and it may be determined how many times, among the 20 times, the position is changed. Same as a purpose of measuring the principal axis displacement speed, a purpose of this manner is to determine a moving speed of the user on the touchscreen.

With reference to the method for implementing remote browsing shown in FIG. 1, for implementation of instructing the server to perform the page scrolling operation in step 103, this embodiment of the present invention further provides the following two methods.

The first method for implementing instructing the server to perform the page scrolling operation is shown in FIG. 2 and includes:

a1031: Acquire a scrolling direction of the operation behavior on a principal axis.

The scrolling direction on the principal axis includes a positive direction of the principal axis and a negative direction of the principal axis.

a1032: Determine a current page scrolling direction according to the scrolling direction of the page on the principal axis.

For determining of the current page scrolling direction, reference may be made to the following principle, where the principle includes:

a positive direction of the longitudinal axis corresponds to scroll up; a negative direction of the longitudinal axis corresponds to scroll down; a positive direction of the lateral axis corresponds to scroll right; and a negative direction of the lateral axis corresponds to scroll left. It should be noted that, specific directions of the positive direction and the negative direction may be set according to a requirement.

a1033: Determine a scrolling displacement amount of the page principal axis according to a principal axis displacement amount.

Implementation of the determining a scrolling displacement amount of the page principal axis according to a principal axis displacement amount may include the following two methods, which are specifically:

The first method: Directly equate the principal axis displacement amount with the scrolling displacement amount of the page principal axis. That is, a value of the scrolling displacement amount of the page principal axis is a value of the principal axis displacement amount.

The second method: Obtain the scrolling displacement amount of the page principal axis by performing enlargement or reduction adjustment on the principal axis displacement amount according to a proportion. The proportion described herein may be determined according to a ratio of a size of the touchscreen to a size of a display format of the server, and certainly, another parameter may also be set according to an empirical value, which is not limited in this embodiment of the present invention.

a1034: Send the current page scrolling direction and the scrolling displacement amount of the page principal axis to the server, so that the server scrolls a currently displayed page according to the current page scrolling direction and the scrolling displacement amount of the page principal axis. Because the client remotely logs in to the server, page content that is obtained after a page displayed on the server is scrolled may be displayed on the touchscreen of the client in real time.

It should be noted that, if there is a scroll bar on the currently displayed page on the touchscreen, the server may further adjust a position of the scroll bar according to the current page scrolling direction and the principal axis displacement amount.

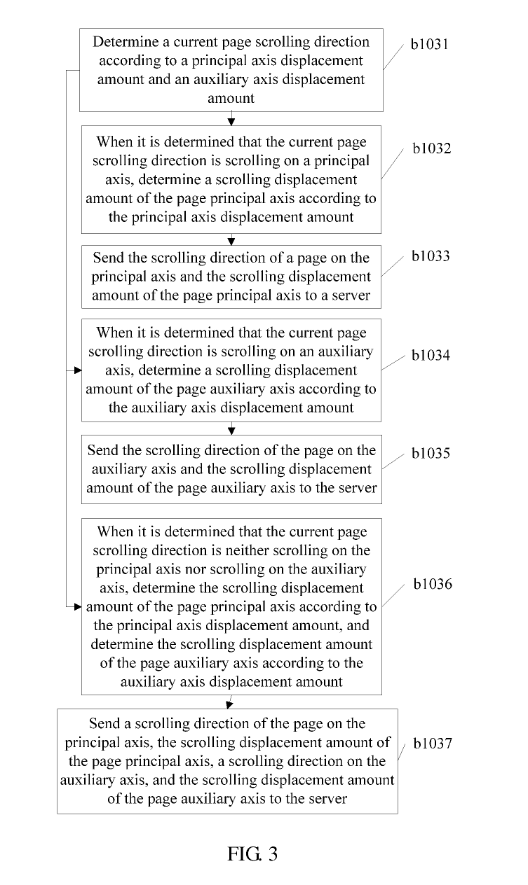

The second method for implementing instructing the server to perform the page scrolling operation is shown in FIG. 3 and includes:

b1031: Determine a current page scrolling direction according to a principal axis displacement amount and an auxiliary axis displacement amount.

The auxiliary axis is the longitudinal axis or the lateral axis of the touchscreen, and is different from the principal axis. For example, if the principal axis is the longitudinal axis, the corresponding auxiliary axis may be the lateral axis; and if the principal axis is the lateral axis, the corresponding auxiliary axis may be the longitudinal axis.

A method for determining the current page scrolling direction according to the principal axis displacement amount and the auxiliary axis displacement amount is specifically as follows:

when a ratio of the principal axis displacement amount to the auxiliary axis displacement amount is less than a first direction threshold, determining that the page scrolls in a direction of the auxiliary axis;

when the ratio of the principal axis displacement amount to the auxiliary axis displacement amount is greater than a second direction threshold, determining that the page scrolls in a direction of the principal axis; and

when the ratio of the principal axis displacement amount to the auxiliary axis displacement amount is neither greater than the second direction threshold nor less than the first direction threshold, determining that the current page scrolling direction is neither on the principal axis nor on the auxiliary axis.

The foregoing first direction threshold and second direction threshold may be customized. For example, the first direction threshold may be tan30°, tan25°, or the like, and the second direction threshold may be tan60°, tan65°, or the like.

b1032: When it is determined that the current page scrolling direction is scrolling on a principal axis, determine a scrolling displacement amount of the page principal axis according to the principal axis displacement amount.

b1033: Send the scrolling direction of the page on the principal axis and the scrolling displacement amount of the page principal axis to the server, so that the server scrolls a currently displayed page according to the scrolling direction of the page on the principal axis and the scrolling displacement amount of the page principal axis.

b1034: When it is determined that the current page scrolling direction is scrolling on an auxiliary axis, determine a scrolling displacement amount of the page auxiliary axis according to the auxiliary axis displacement amount.

b1035: Send the scrolling direction of the page on the auxiliary axis and the scrolling displacement amount of the page auxiliary axis to the server, so that the server scrolls the currently displayed page according to the scrolling direction of the page on the auxiliary axis and the scrolling displacement amount of the page auxiliary axis.

b1036: When it is determined that the current page scrolling direction is neither scrolling on the principal axis nor scrolling on the auxiliary axis, determine the scrolling displacement amount of the page principal axis according to the principal axis displacement amount, and determine the scrolling displacement amount of the page auxiliary axis according to the auxiliary axis displacement amount.

b1037: Send a scrolling direction of the page on the principal axis, the scrolling displacement amount of the page principal axis, a scrolling direction on the auxiliary axis, and the scrolling displacement amount of the page auxiliary axis to the server, so that the server scrolls the currently displayed page according to the scrolling direction of the page on the principal axis, the scrolling displacement amount of the page principal axis, the scrolling direction on the auxiliary axis, and the scrolling displacement amount of the page auxiliary axis.

With reference to the method for implementing remote browsing shown in FIG. 1, for implementation of instructing, according to the preset page flipping rule, the server to perform the page flipping operation of the page in step 104, this embodiment of the present invention further provides the following three methods.

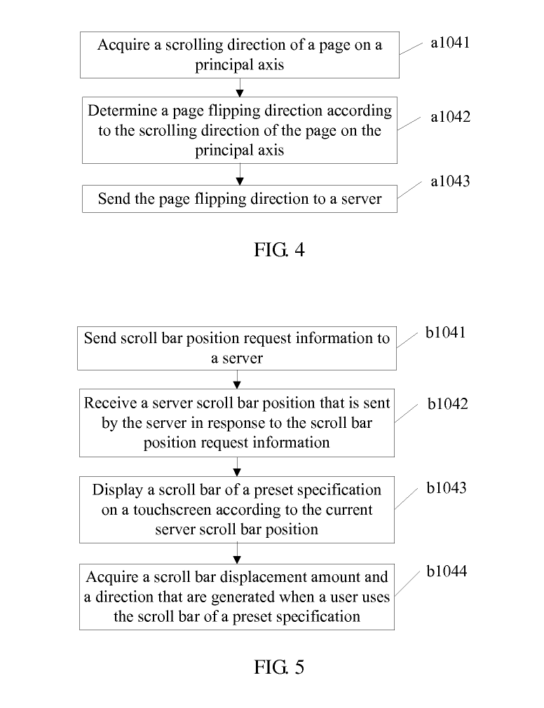

The first method for implementing instructing, according to the preset page flipping rule, the server to perform the page flipping operation of the page is shown in FIG. 4 and includes:

a1041: Acquire a scrolling direction of the page on a principal axis.

a1042: Determine a page flipping direction according to the scrolling direction of the page on the principal axis.

The determining a page flipping direction according to the scrolling direction of the page on the principal axis may be implemented by complying with the following principle: A positive direction of the longitudinal axis corresponds to page up; a negative direction of the longitudinal axis corresponds to page down; a positive direction of the lateral axis corresponds to page right; and a negative direction of the lateral axis corresponds to page left.

a1043: Send the page flipping direction to the server, so that the server adjusts a currently displayed page according to the page flipping direction.

In the method described in a1041 to a1043, the server may flip one or more pages in response to the page flipping direction.

The second method for implementing instructing, according to the preset page flipping rule, the server to perform the page flipping operation of the page is shown in FIG. 5 and includes:

b1041: Send scroll bar position request information to the server.

b1042: Receive a server scroll bar position that is sent by the server in response to the scroll bar position request information.

b1043: Display a scroll bar of a preset specification on the touchscreen according to the current server scroll bar position.

A principle for setting the preset specification is making it convenient for the user to tap and drag the scroll bar on the touchscreen; therefore, the scroll bar of a preset specification may be set to be larger than a currently displayed scroll bar, or the like.

b1044: Acquire a scroll bar displacement amount and a direction that are generated when the user uses the scroll bar of a preset specification.

b1045: Send, to the server, the scroll bar displacement amount and the direction that are generated when the user uses the scroll bar of a preset specification, so that the server adjusts a currently displayed page and the server scroll bar position according to the scroll bar displacement amount and the direction that are generated when the user uses the scroll bar of a preset specification.

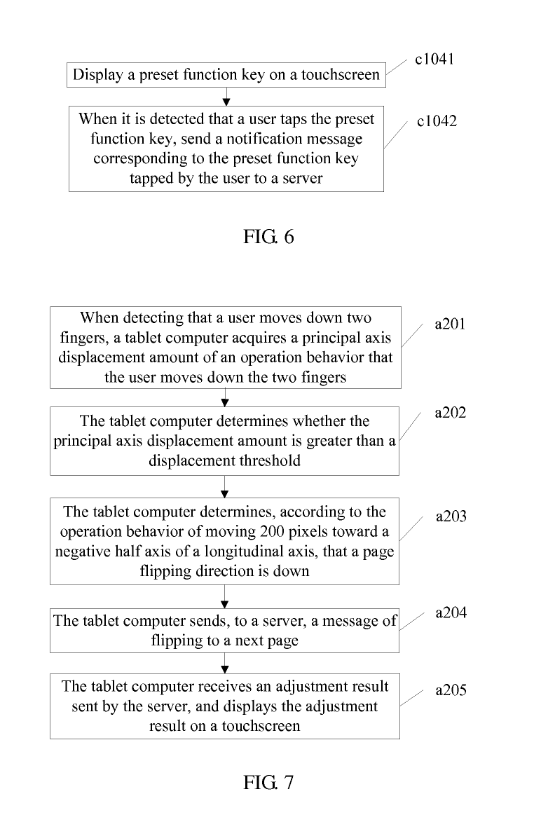

The third method for implementing instructing, according to the preset page flipping rule, the server to perform the page flipping operation of the page is shown in FIG. 6 and includes:

c1041: Display a preset function key on the touchscreen, where the preset function key includes a Page Up key or a Page Down key or both.

The preset function key may be not limited only to the set Page Up key and Page Down key. For example, a preset function key display or hide button may also be set. Further, in a process of displaying the preset function key, only one function key may be displayed selectively according to an operation direction of the user. For example, if it is detected that the user slides down, only the Page Down key may be displayed; and if it is detected that the user slides up, only the Page Up key may be displayed.

c1042: When it is detected that the user taps the preset function key, send a notification message corresponding to the preset function key tapped by the user to the server, so that the server adjusts a currently displayed page according to the notification message corresponding to the preset function key tapped by the user.

For example, when the preset function key tapped by the user is the Page Up key, the server may perform a page up operation on the currently displayed page; and when the preset function key tapped by the user is the Page Down key, the server may perform a page down operation on the currently displayed page.

It should be noted that, after the preset function key is displayed on the touchscreen, the user may cancel display of the preset function key by using another function key or by using a gesture, for example, dragging, on the touchscreen.

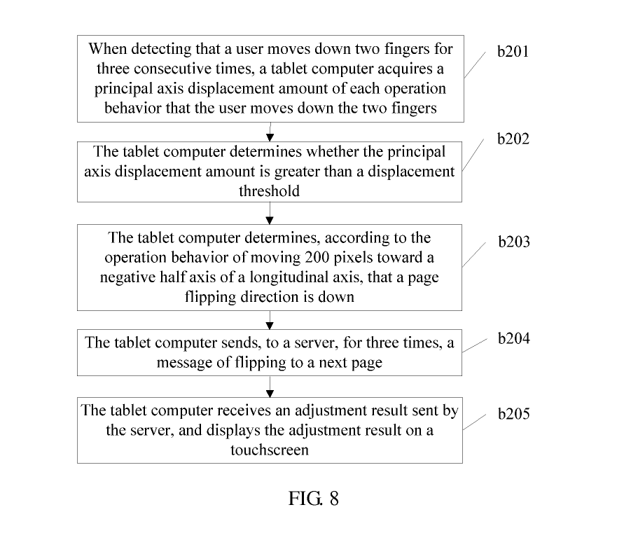

Herein, the method for implementing remote browsing provided by this embodiment of the present invention is described in detail with reference to an actual application scenario. In a first possible scenario, as shown in FIG. 7, a method procedure in which the client is a tablet computer is described, and the method includes:

a201: When detecting that a user moves down two fingers, a tablet computer acquires a principal axis displacement amount of the operation behavior that the user moves down the two fingers.

In this embodiment, the operation behavior that the user moves down the two fingers completes moving 200 pixels toward a negative half axis of a longitudinal axis within 100 ms, and a principal axis is set as the longitudinal axis.

It can be understood that the operation behavior described in this embodiment is implemented by the user by using two fingers, and in an actual application, the operation behavior of the user may also be implemented by using a single finger.

a202: The tablet computer determines whether the principal axis displacement amount is greater than a displacement threshold.

In this implementation, the threshold is 100 pixels. In this case, the principal axis displacement amount is greater than the displacement threshold.

a203: The tablet computer determines, according to the operation behavior of moving 200 pixels toward a negative half axis of a longitudinal axis that a page flipping direction is down.

a204: The tablet computer sends, to a server, a message of flipping to a next page.

a205: The tablet computer receives an adjustment result sent by the server, and displays the adjustment result on a touchscreen.

Herein, the method for implementing remote browsing provided by this embodiment of the present invention is described in detail with reference to an actual application scenario. In a second possible scenario, as shown in FIG. 8, the method includes:

b201: When detecting that a user moves down two fingers for three consecutive times, a tablet computer acquires a principal axis displacement amount of the operation behavior that the user moves down the two fingers for three times.

In this embodiment, that the user moves down the two fingers each time completes moving 200 pixels toward a negative half axis of a longitudinal axis within 100 ms, and a principal axis is set as the longitudinal axis.

b202: The tablet computer determines whether the principal axis displacement amount is greater than a displacement threshold.

In this implementation, the threshold is 100 pixels. In this case, the principal axis displacement amount is greater than the displacement threshold.

b203: The tablet computer determines, according to the operation behavior of moving 200 pixels toward a negative half axis of a longitudinal axis that a page flipping direction is down.

b204: The tablet computer sends, to a server, for three times, a message of flipping to a next page.

b205: The tablet computer receives an adjustment result sent by the server, and displays the adjustment result on a touchscreen.

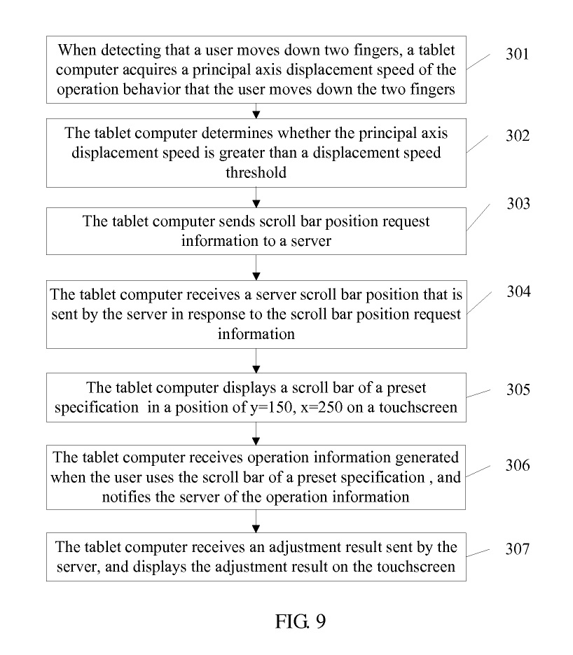

In a third possible scenario, as shown in FIG. 9, the method includes:

301: When detecting that a user moves down two fingers, a tablet computer acquires a principal axis displacement speed of the operation behavior that the user moves down the two fingers.

In this embodiment, the operation behavior that the user moves down the two fingers completes moving 200 pixels toward a negative half axis of a longitudinal axis within 100 ms, and a principal axis is set as the longitudinal axis. Therefore, the principal axis displacement speed is 200/100=2 pixels/ms.

302: The tablet computer determines whether the principal axis displacement speed is greater than a displacement speed threshold.

In this implementation, the threshold is 1 pixel/ms. In this case; the principal axis displacement speed is greater than the displacement speed threshold.

303: The tablet computer sends scroll bar position request information to a server.

304: The tablet computer receives a server scroll bar position that is sent by the server in response to the scroll bar position request information.

In this embodiment, the server scroll bar position is: y=300, x=500.

305: The tablet computer displays a scroll bar of a preset specification in a position of y=150, x=250 on a touchscreen.

306: The tablet computer receives operation information generated when the user uses the scroll bar of a preset specification, and notifies the server of the operation information.

307: The tablet computer receives an adjustment result sent by the server, and displays the adjustment result on the touchscreen.

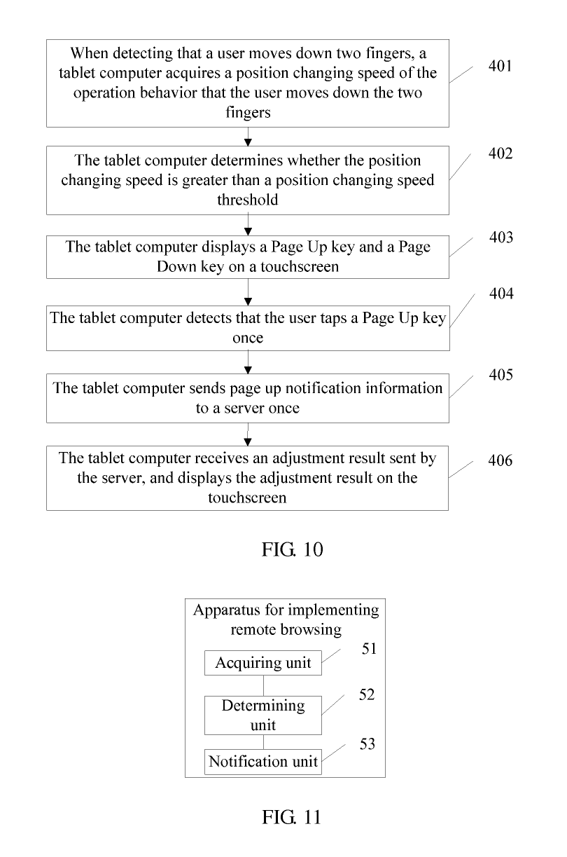

In a fourth possible scenario, as shown in FIG. 10, the method includes:

401: When detecting that a user moves down two fingers, a tablet computer acquires a position changing speed of the operation behavior that the user moves down the two fingers.

In this embodiment, the operation behavior that the user moves down the two fingers completes moving 200 pixels toward a negative half axis of a longitudinal axis within 100 ms, a position is changed for 15 times, and a principal axis is set as the longitudinal axis. Therefore, the position changing speed is 15/100=0.15.

402: The tablet computer determines whether the position changing speed is greater than a position changing speed threshold.

In this implementation, the position changing speed threshold is 0.1. In this case, the position changing speed is greater than the position changing speed threshold.

403: The tablet computer displays a Page Up key and a Page Down key on a touchscreen.

404: The tablet computer detects that the user taps a Page Up key once.

405: The tablet computer sends page up notification information to a server once.

406: The tablet computer receives an adjustment result sent by the server, and displays the adjustment result on the touchscreen.

In the method for implementing remote browsing provided by this embodiment of the present invention, an intention, of a user, of determining page scrolling and page flipping is determined by using a motion characteristic parameter corresponding to an operation behavior of the user on a touchscreen, so that the user can implement adjustment of page display content by using an operation in any position of the touchscreen, and the user may perform a corresponding operation according to the intention of the user, so as to implement fast page flipping or merely make relatively small displacement of a page. Compared with the prior art in which only a reduced or deformed scroll bar can be used, this embodiment of the present invention can implement that the user fast and accurately browses content with a scroll bar.

An embodiment of the present invention further provides an apparatus for implementing remote browsing, and the apparatus may be used to implement all procedures of the foregoing methods shown in FIG. 1 to FIG. 10. The apparatus for implementing remote browsing provided by this embodiment of the present invention may include a device that has touchscreen hardware and corresponding software support, for example, a smartphone and a tablet computer. As shown in FIG. 11, a structure of the apparatus for implementing remote browsing provided by this embodiment of the present invention is described, and the apparatus for implementing remote browsing includes: an acquiring unit 51, a determining unit 52, and a notification unit 53.

The acquiring unit 51 is configured to, when it is detected that an operation behavior of a user on a touchscreen meets a preset manner, acquire a motion characteristic parameter of the operation behavior.

The determining unit 52 is configured to determine whether the motion characteristic parameter acquired by the acquiring unit 51 exceeds a threshold.

The notification unit 53 is configured to: when the determining unit 52 determines that the motion characteristic parameter does not exceed the threshold, instruct a server to perform a page scrolling operation; and when the determining unit determines that the motion characteristic parameter exceeds the threshold, instruct, according to a preset page flipping rule, the server to perform a page flipping operation of a page.

Optionally, the motion characteristic parameter is any one of the following parameters:

a principal axis displacement amount, where a principal axis is a lateral axis or a longitudinal axis of the touchscreen, and the principal axis displacement amount is used to indicate a displacement amount of the operation behavior on the principal axis;

a principal axis displacement speed, where the principal axis displacement speed is used to indicate a displacement speed of the operation behavior in a direction of the principal axis; and

a position changing speed, where the position changing speed is used to indicate a speed at which a position of a touch point between the user and the touchscreen in the operation behavior is changed.

Optionally, the determining unit 52 is specifically configured to: when the motion characteristic parameter includes the principal axis displacement amount, determine whether the principal axis displacement amount is greater than a displacement threshold; when it is determined that the principal axis displacement amount is greater than the displacement threshold, determine that the motion characteristic parameter exceeds the threshold; and

when it is determined that the principal axis displacement amount is not greater than the displacement threshold, determine that the motion characteristic parameter does not exceed the threshold.

Optionally, the determining unit 52 is specifically configured to: when the motion characteristic parameter includes the principal axis displacement speed, determine whether the principal axis displacement speed is greater than a displacement speed threshold; when it is determined that the principal axis displacement speed is greater than the displacement speed threshold, determine that the motion characteristic parameter exceeds the threshold; and when it is determined that the principal axis displacement speed is not greater than the displacement speed threshold, determine that the motion characteristic parameter does not exceed the threshold.

Optionally, the determining unit 52 is specifically configured to: when the motion characteristic parameter includes the position changing speed, determine whether the position changing speed is greater than a position changing speed threshold; when it is determined that the position changing speed is greater than the position changing speed threshold, determine that the motion characteristic parameter exceeds the threshold; and when it is determined that the position changing speed is not greater than the position changing speed threshold, determine that the motion characteristic parameter does not exceed the threshold.

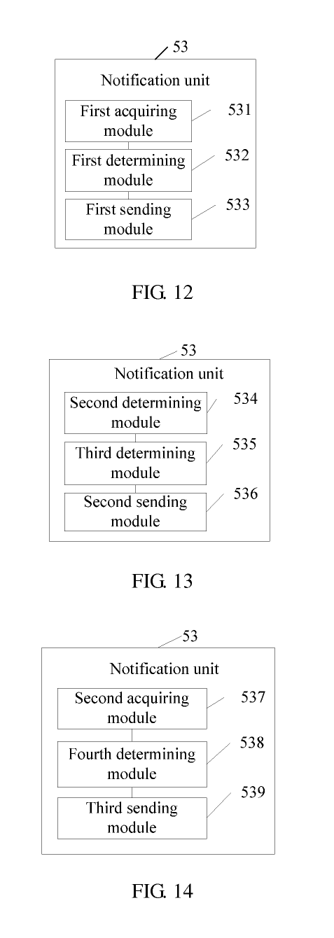

Optionally, as shown in FIG. 12, the notification unit 53 includes: a first acquiring module 531, a first determining module 532, and a first sending module 533.

The first acquiring module 531 is configured to acquire a scrolling direction of the operation behavior on the principal axis.

The first determining module 532 is configured to: determine a current page scrolling direction according to the scrolling direction of the page on the principal axis acquired by the first acquiring module 531; and determine a scrolling displacement amount of the page principal axis according to the principal axis displacement amount.

The first sending module 533 is configured to send, to the server, the current page scrolling direction and the scrolling displacement amount of the page principal axis that are determined by the first determining module 532, so that the server scrolls a currently displayed page according to the current page scrolling direction and the scrolling displacement amount of the page principal axis.

Optionally, as shown in FIG. 13, the notification unit 53 includes: a second determining module 534, a third determining module 535, and a second sending module 536.

The second determining module 534 is configured to determine a current page scrolling direction according to the principal axis displacement amount and an auxiliary axis displacement amount, where the auxiliary axis is the longitudinal axis or the lateral axis of the touchscreen, and is different from the principal axis.

The third determining module 535 is configured to: when it is determined that the current page scrolling direction is scrolling on the principal axis, determine a scrolling displacement amount of the page principal axis according to the principal axis displacement amount; when it is determined that the current page scrolling direction is scrolling on the auxiliary axis, determine a scrolling displacement amount of the page auxiliary axis according to the auxiliary axis displacement amount; and when it is determined that the current page scrolling direction is neither on the principal axis nor on the auxiliary axis, determine the scrolling displacement amount of the page principal axis according to the principal axis displacement amount, and determine the scrolling displacement amount of the page auxiliary axis according to the auxiliary axis displacement amount.

The second sending module 536 is configured to: send the scrolling direction of the page on the principal axis and the scrolling displacement amount of the page principal axis to the server, so that the server scrolls a currently displayed page according to the scrolling direction of the page on the principal axis and the scrolling displacement amount of the page principal axis; send the scrolling direction of the page on the auxiliary axis and the scrolling displacement amount of the page auxiliary axis to the server, so that the server scrolls the currently displayed page according to the scrolling direction of the page on the auxiliary axis and the scrolling displacement amount of the page auxiliary axis; and send a scrolling direction of the page on the principal axis, the scrolling displacement amount of the page principal axis, a scrolling direction on the auxiliary axis, and the scrolling displacement amount of the page auxiliary axis to the server, so that the server scrolls the currently displayed page according to the scrolling direction of the page on the principal axis, the scrolling displacement amount of the page principal axis, the scrolling direction on the auxiliary axis, and the scrolling displacement amount of the page auxiliary axis.

Optionally, the second determining module 534 is specifically configured to: when a ratio of the principal axis displacement amount to the auxiliary axis displacement amount is less than a first direction threshold, determine that the page scrolls in a direction of the auxiliary axis; when the ratio of the principal axis displacement amount to the auxiliary axis displacement amount is greater than a second direction threshold, determine that the page scrolls in a direction of the principal axis; and when the ratio of the principal axis displacement amount to the auxiliary axis displacement amount is neither greater than the second direction threshold nor less than the first direction threshold, determine that the current page scrolling direction is neither on the principal axis nor on the auxiliary axis.

Optionally, as shown in FIG. 14, the notification unit 53 further includes: a second acquiring module 537, a fourth determining module 538, and a third sending module 539.

The second acquiring module 537 is configured to acquire a scrolling direction of the page on the principal axis.

The fourth determining module 538 is configured to determine a page flipping direction according to the scrolling direction of the page on the principal axis acquired by the second acquiring module 537.

The third sending module 539 is configured to send the page flipping direction determined by the fourth determining module 538 to the server, so that the server adjusts a currently displayed page according to the page flipping direction.

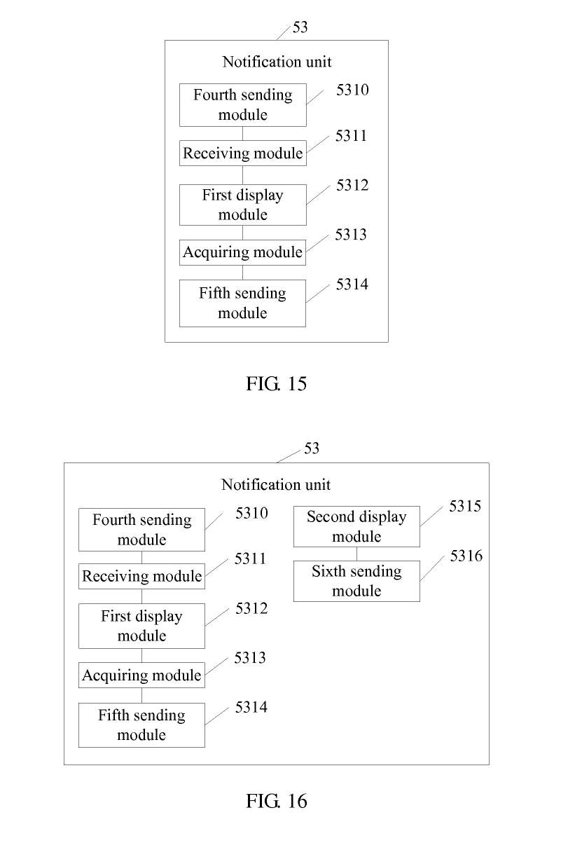

Optionally, as shown in FIG. 15, the notification unit 53 includes: a fourth sending module 5310, a receiving module 5311, a first display module 5312, an acquiring module 5313, and a fifth sending module 5314.

The fourth sending module 5310 is configured to send scroll bar position request information to the server.

The receiving module 5311 is configured to receive a server scroll bar position that is sent by the server in response to the scroll bar position request information.

The first display module 5312 is configured to display a scroll bar of a preset specification on the touchscreen according to the current server scroll bar position received by the receiving module 5311.

The acquiring module 5313 is configured to acquire a scroll bar displacement amount and a direction that are generated when the user uses the scroll bar of a preset specification.

The fifth sending module 5314 is configured to send, to the server, the scroll bar displacement amount and the direction that are generated when the user uses the scroll bar of a preset specification and are acquired by the acquiring module 5313, so that the server adjusts a currently displayed page and the server scroll bar position according to the scroll bar displacement amount and the direction that are generated when the user uses the scroll bar of a preset specification.

Optionally, as shown in FIG. 16, the notification unit 53 includes: a second display module 5315 and a sixth sending module 5316.

The second display module 5315 is configured to display a preset function key on the touchscreen, where the preset function key includes a Page Up key or a Page Down key or both.

The sixth sending module 5316 is configured to: when it is detected that the user taps the preset function key, send a notification message corresponding to the preset function key tapped by the user to the server, so that the server adjusts a currently displayed page according to the notification message corresponding to the preset function key tapped by the user.

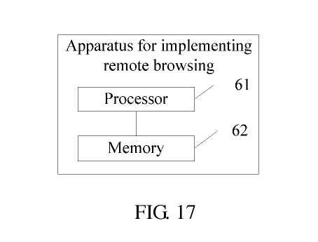

An embodiment of the present invention further provides an apparatus for implementing remote browsing, and the apparatus may also implement the steps of the methods shown in FIG. 1 to FIG. 10. As shown in FIG. 17, the apparatus includes a processor 61 and a memory 62.

The processor 61 is configured to: when it is detected that an operation behavior of a user on a touchscreen meets a preset manner, acquire a motion characteristic parameter of the operation behavior; determine whether the motion characteristic parameter exceeds a threshold; when it is determined that the motion characteristic parameter does not exceed the threshold, instruct a server to perform a page scrolling operation; and when it is determined that the motion characteristic parameter exceeds the threshold, instruct, according to a preset page flipping rule, the server to perform a page flipping operation of a page.

The memory 62 is configured to store the motion characteristic parameter and the threshold.

Optionally, the motion characteristic parameter is any one of the following parameters:

a principal axis displacement amount, where a principal axis is a lateral axis or a longitudinal axis of the touchscreen, and the principal axis displacement amount is used to indicate a displacement amount of the operation behavior on the principal axis;

a principal axis displacement speed, where the principal axis displacement speed is used to indicate a displacement speed of the operation behavior in a direction of the principal axis; and

a position changing speed, where the position changing speed is used to indicate a speed at which a position of a touch point between the user and the touchscreen in the operation behavior is changed.

Optionally, the processor 61 is further configured to: when the motion characteristic parameter includes the principal axis displacement amount, determine whether the principal axis displacement amount is greater than a displacement threshold; when it is determined that the principal axis displacement amount is greater than the displacement threshold, determine that the motion characteristic parameter exceeds the threshold; and when it is determined that the principal axis displacement amount is not greater than the displacement threshold, determine that the motion characteristic parameter does not exceed the threshold.

Optionally, the processor 61 is further configured to: when the motion characteristic parameter includes the principal axis displacement speed, determine whether the principal axis displacement speed is greater than a displacement speed threshold; when it is determined that the principal axis displacement speed is greater than the displacement speed threshold, determine that the motion characteristic parameter exceeds the threshold; and when it is determined that the principal axis displacement speed is not greater than the displacement speed threshold, determine that the motion characteristic parameter does not exceed the threshold.

Optionally, the processor 61 is further configured to: when the motion characteristic parameter includes the position changing speed, determine whether the position changing speed is greater than a position changing speed threshold; when it is determined that the position changing speed is greater than the position changing speed threshold, determine that the motion characteristic parameter exceeds the threshold; and when it is determined that the position changing speed is not greater than the position changing speed threshold, determine that the motion characteristic parameter does not exceed the threshold.

Optionally, the processor 61 is further configured to: acquire a scrolling direction of the operation behavior on the principal axis, and determine a current page scrolling direction according to the scrolling direction of the page on the principal axis; determine a scrolling displacement amount of the page principal axis according to the principal axis displacement amount; and send the current page scrolling direction and the scrolling displacement amount of the page principal axis to the server, so that the server scrolls a currently displayed page according to the current page scrolling direction and the scrolling displacement amount of the page principal axis.

The memory 62 is further configured to store the current page scrolling direction and the scrolling displacement amount of the page principal axis.

The processor 61 is further configured to determine a current page scrolling direction according to the principal axis displacement amount and an auxiliary axis displacement amount, where the auxiliary axis is the longitudinal axis or the lateral axis of the touchscreen, and is different from the principal axis; and

when it is determined that the current page scrolling direction is scrolling on the principal axis, determine a scrolling displacement amount of the page principal axis according to the principal axis displacement amount, and send the scrolling direction of the page on the principal axis and the scrolling displacement amount of the page principal axis to the server, so that the server scrolls a currently displayed page according to the scrolling direction of the page on the principal axis and the scrolling displacement amount of the page principal axis; when it is determined that the current page scrolling direction is scrolling on the auxiliary axis, determine a scrolling displacement amount of the page auxiliary axis according to the auxiliary axis displacement amount, and send the scrolling direction of the page on the auxiliary axis and the scrolling displacement amount of the page auxiliary axis to the server, so that the server scrolls the currently displayed page according to the scrolling direction of the page on the auxiliary axis and the scrolling displacement amount of the page auxiliary axis; and when it is determined that the current page scrolling direction is neither on the principal axis nor on the auxiliary axis, determine the scrolling displacement amount of the page principal axis according to the principal axis displacement amount, determine the scrolling displacement amount of the page auxiliary axis according to the auxiliary axis displacement amount, and send a scrolling direction of the page on the principal axis, the scrolling displacement amount of the page principal axis, a scrolling direction on the auxiliary axis, and the scrolling displacement amount of the page auxiliary axis to the server, so that the server scrolls the currently displayed page according to the scrolling direction of the page on the principal axis, the scrolling displacement amount of the page principal axis, the scrolling direction on the auxiliary axis, and the scrolling displacement amount of the page auxiliary axis.

The memory 62 is further configured to store the auxiliary axis displacement amount, the scrolling direction on the auxiliary axis, and the scrolling displacement amount of the page auxiliary axis.

The processor 61 is further configured to: when a ratio of the principal axis displacement amount to the auxiliary axis displacement amount is less than a first direction threshold, determine that the page scrolls in a direction of the auxiliary axis; when the ratio of the principal axis displacement amount to the auxiliary axis displacement amount is greater than a second direction threshold, determine that the page scrolls in a direction of the principal axis; and when the ratio of the principal axis displacement amount to the auxiliary axis displacement amount is neither greater than the second direction threshold nor less than the first direction threshold, determine that the current page scrolling direction is neither on the principal axis nor on the auxiliary axis.

The memory 62 is further configured to store the first direction threshold and the second direction threshold.

The processor 61 is further configured to: acquire a scrolling direction of the page on the principal axis; determine a page flipping direction according to the scrolling direction of the page on the principal axis; and send the page flipping direction to the server, so that the server adjusts a currently displayed page according to the page flipping direction.

The memory 62 is further configured to store the page flipping direction.

The processor 61 is further configured to: send scroll bar position request information to the server; receive a server scroll bar position that is sent by the server in response to the scroll bar position request information; display a scroll bar of a preset specification on the touchscreen according to the current server scroll bar position; acquire a scroll bar displacement amount and a direction that are generated when the user uses the scroll bar of a preset specification; and send, to the server, the scroll bar displacement amount and the direction that are generated when the user uses the scroll bar of a preset specification, so that the server adjusts a currently displayed page and the server scroll bar position according to the scroll bar displacement amount and the direction that are generated when the user uses the scroll bar of a preset specification.

The memory 62 is further configured to store the server scroll bar position, the scroll bar of a preset specification, and the scroll bar displacement amount and the direction that are generated when the user uses the scroll bar of a preset specification.

The processor 61 is further configured to: display a preset function key on the touchscreen, where the preset function key includes a Page Up key and a Page Down key; and when it is detected that the user taps the preset function key, send a notification message corresponding to the preset function key tapped by the user to the server, so that the server adjusts a currently displayed page according to the notification message corresponding to the preset function key tapped by the user.

In the method and the apparatus for implementing remote browsing provided by the embodiments of the present invention, an intention, of a user, of determining page scrolling and page flipping is determined by using a motion characteristic parameter corresponding to an operation behavior of the user on a touchscreen, so that the user can implement adjustment of page display content by using an operation in any position of the touchscreen, and the user may perform a corresponding operation according to the intention of the user, so as to implement fast page flipping or merely make relatively small displacement of a page. Compared with the prior art in which only a reduced or deformed scroll bar can be used, the embodiments of the present invention can implement that the user fast and accurately browses content with a scroll bar.

Based on the foregoing descriptions of the implementation manners, a person skilled in the art may clearly understand that the present invention may be implemented by software in addition to necessary universal hardware or by hardware only. In most circumstances, the former is a preferred implementation manner. Based on such an understanding, the technical solutions of the present invention essentially or the part contributing to the prior art may be implemented in a form of a software product. The software product is stored in a readable storage medium, such as a floppy disk, a hard disk or an optical disc of a computer, and includes several instructions for instructing a computer device (which may be a personal computer, a server, or a network device) to perform the methods described in the embodiments of the present invention.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for implementing remote browsing on a client comprising a touchscreen, comprising:
acquiring a motion characteristic parameter of an operation behavior of a user on a touchscreen in response to detecting that the operation behavior meets a preset manner;
determining whether the motion characteristic parameter exceeds a threshold;
instructing a server to perform a page scrolling operation in response to determining that the motion characteristic parameter does not exceed the threshold; and
instructing, in response to determining that the motion characteristic parameter exceeds the threshold, the server to perform a page flipping operation according to a preset page flipping rule.

2. The method according to claim 1, wherein the motion characteristic parameter comprises at least one of:
a principal axis displacement amount, wherein a principal axis is a lateral axis or a longitudinal axis of the touchscreen, and the principal axis displacement amount indicates a displacement amount of the operation behavior on the principal axis;
a principal axis displacement speed, wherein the principal axis displacement speed indicates a displacement speed of the operation behavior in a direction of the principal axis; and
a position changing speed, wherein the position changing speed indicates a speed at which a position of a touch point between the user and the touchscreen in the operation behavior is changed.

3. The method according to claim 2, wherein, when the motion characteristic parameter is the principal axis displacement amount, the determining whether the motion characteristic parameter exceeds a threshold comprises:
determining whether the principal axis displacement amount is greater than a displacement threshold;
determining, in response to determining that the principal axis displacement amount is greater than the displacement threshold, that the motion characteristic parameter exceeds the threshold; and
determining, in response to determining that the principal axis displacement amount is not greater than the displacement threshold, that the motion characteristic parameter does not exceed the threshold.

4. The method according to claim 2, wherein, when the motion characteristic parameter comprises the principal axis displacement speed, the determining whether the motion characteristic parameter exceeds a threshold comprises:
determining whether the principal axis displacement speed is greater than a displacement speed threshold;
determining, in response to determining that the principal axis displacement speed is greater than the displacement speed threshold, that the motion characteristic parameter exceeds the threshold; and
determining, in response to determining that the principal axis displacement speed is not greater than the displacement speed threshold, that the motion characteristic parameter does not exceed the threshold.

5. The method according to claim 2, wherein, when the motion characteristic parameter comprises the position changing speed, the determining whether the motion characteristic parameter exceeds a threshold comprises:
determining whether the position changing speed is greater than a position changing speed threshold;
determining, in response to determining that the position changing speed is greater than the position changing speed threshold, that the motion characteristic parameter exceeds the threshold; and
determining, in response to determining that the position changing speed is not greater than the position changing speed threshold, that the motion characteristic parameter does not exceed the threshold.

6. The method according to claim 1, wherein the instructing a server to perform page scrolling operation comprises:
acquiring a scrolling direction of the operation behavior on a principal axis, and determining a current page scrolling direction according to the scrolling direction of a page on the principal axis;
determining a scrolling displacement amount of a page principal axis according to a principal axis displacement amount; and
sending the current page scrolling direction and the scrolling displacement amount of the page principal axis to the server, so that the server scrolls a currently displayed page according to the current page scrolling direction and the scrolling displacement amount of the page principal axis.

7. The method according to claim 1, wherein the instructing a server to perform a page scrolling operation comprises:
determining a current page scrolling direction according to a principal axis displacement amount and an auxiliary axis displacement amount, wherein the auxiliary axis is a longitudinal axis or a lateral axis of the touchscreen, and is different from the principal axis;
determining, in response to determining that the current page scrolling direction is on a principal axis, a scrolling displacement amount of a page principal axis according to the principal axis displacement amount, and sending a scrolling direction of the page on the principal axis and the scrolling displacement amount of the page principal axis to the server, so that the server scrolls a currently displayed page according to the scrolling direction of the page on the principal axis and the scrolling displacement amount of the page principal axis;
determining, in response to determining that the current page scrolling direction is on the auxiliary axis, a scrolling displacement amount of a page auxiliary axis according to the auxiliary axis displacement amount, and sending the scrolling direction of the page on the auxiliary axis and the scrolling displacement amount of the page auxiliary axis to the server, so that the server scrolls the currently displayed page according to the scrolling direction of the page on the auxiliary axis and the scrolling displacement amount of the page auxiliary axis; and
determining, in response to determining that the current page scrolling direction is neither on the principal axis nor on the auxiliary axis, the scrolling displacement amount of the page principal axis according to the principal axis displacement amount, determining the scrolling displacement amount of the auxiliary axis page according to the auxiliary axis displacement amount, and sending a scrolling direction of the page on the principal axis, the scrolling displacement amount of the page principal axis, a scrolling direction on the auxiliary axis, and the scrolling displacement amount of the page auxiliary axis to the server, so that the server scrolls the currently displayed page according to the scrolling direction of the page on the principal axis, the scrolling displacement amount of the page principal axis, the scrolling direction on the auxiliary axis, and the scrolling displacement amount of the page auxiliary axis.

8. The method according to claim 7, wherein the determining a current page scrolling direction according to the principal axis displacement amount and an auxiliary axis displacement amount comprises:
determining that the page scrolls in a direction of the auxiliary axis when a ratio of the principal axis displacement amount to the auxiliary axis displacement amount is less than a first direction threshold;
determining that the page scrolls in a direction of the principal axis when the ratio of the principal axis displacement amount to the auxiliary axis displacement amount is greater than a second direction threshold; and
determining that the current page scrolling direction is neither on the principal axis nor on the auxiliary axis when the ratio of the principal axis displacement amount to the auxiliary axis displacement amount is neither greater than the second direction threshold nor less than the first direction threshold.

9. The method according to claim 1, wherein the instructing the server to perform a page flipping operation according to a preset page flipping rule, of a page comprises:
acquiring a scrolling direction of the page on a principal axis;
determining a page flipping direction according to the scrolling direction of the page on the principal axis; and
sending the page flipping direction to the server, so that the server adjusts a currently displayed page according to the page flipping direction.

10. The method according to claim 1, wherein the instructing the server to perform a page flipping operation of a page according to a preset page flipping rule comprises:
sending scroll bar position request information to the server;
receiving a server scroll bar position that is sent by the server in response to the scroll bar position request information;
displaying a scroll bar of a preset specification on the touchscreen according to a current server scroll bar position;
acquiring a scroll bar displacement amount and a scroll bar displacement direction that are generated when the user uses the scroll bar of a preset specification; and
sending the scroll bar displacement amount and the direction to the server, so that the server adjusts a currently displayed page and the server scroll bar position according to the scroll bar displacement amount and the direction.

11. The method according to claim 1, wherein the instructing the server to perform a page flipping operation of a page according to a preset page flipping rule, comprises:
displaying a preset function key on the touchscreen, wherein the preset function key comprises a Page Up key, a Page Down key or both the Page Up key and the Page Down key; and
sending, in response to detecting that a user taps the preset function key, a notification message corresponding to the preset function key tapped by the user to the server, so that the server adjusts a currently displayed page according to the notification message corresponding to the preset function key tapped by the user.

12. An apparatus for implementing remote browsing, comprising:
a touchscreen;
a processor connected to the touchscreen; and
a non-transitory computer readable medium connected to the processor and having stored thereon instructions that, when executed, cause the processor to:
acquire, in response to detecting that an operation behavior of a user on the touchscreen meets a preset manner, a motion characteristic parameter of the operation behavior;
determine whether the acquired motion characteristic parameter exceeds a threshold;
instruct a server, in response to determining that the motion characteristic parameter does not exceed the threshold, to perform a page scrolling operation; and
instruct, in response to determining that the motion characteristic parameter exceeds the threshold, the server to perform a page flipping operation according to a preset page flipping rule.

13. The apparatus according to claim 12, wherein the acquired motion characteristic parameter comprises at least one of:
a principal axis displacement amount, wherein a principal axis is a lateral axis or a longitudinal axis of the touchscreen, and the principal axis displacement amount is used to indicate a displacement amount of the operation behavior on the principal axis;
a principal axis displacement speed, wherein the principal axis displacement speed is used to indicate a displacement speed of the operation behavior in a direction of the principal axis; and
a position changing speed, wherein the position changing speed is used to indicate a speed at which a position of a touch point between the user and the touchscreen in the operation behavior is changed.

14. The apparatus according to claim 13, wherein the instructions causing the processor to determine whether the acquired motion characteristic parameter exceeds a threshold comprise instructions, that when executed, cause the processor to:
determine whether the principal axis displacement amount is greater than a displacement threshold when the motion characteristic parameter comprises the principal axis displacement amount;
determine, in response to determining that the principal axis displacement amount is greater than the displacement threshold, that the motion characteristic parameter exceeds the threshold; and
determine, in response to determining that the principal axis displacement amount is not greater than the displacement threshold, that the motion characteristic parameter does not exceed the threshold.

15. The apparatus according to claim 13, wherein the instructions causing the processor to determine whether the acquired motion characteristic parameter exceeds a threshold comprise instructions, that when executed, cause the processor to:
determine whether the principal axis displacement speed is greater than a displacement speed threshold when the motion characteristic parameter comprises the principal axis displacement speed;
determine, in response to determining that the principal axis displacement speed is greater than the displacement speed threshold, that the motion characteristic parameter exceeds the threshold; and
determine, in response to determining that the principal axis displacement speed is not greater than the displacement speed threshold, that the motion characteristic parameter does not exceed the threshold.

16. The apparatus according to claim 13, wherein the instructions causing the processor to determine whether the acquired motion characteristic parameter exceeds a threshold comprise instructions, that when executed, cause the processor to:
determine whether the position changing speed is greater than a position changing speed threshold when the motion characteristic parameter comprises the position changing speed;
determine in response to determining that the position changing speed is greater than the position changing speed threshold that the motion characteristic parameter exceeds the threshold; and
determine, in response to determining that the position changing speed is not greater than the position changing speed threshold, that the motion characteristic parameter does not exceed the threshold.

17. The apparatus according to claim 12, wherein the non-transitory computer readable medium further has stored thereon instructions, that when executed, cause the processor to:
acquire a scrolling direction of the operation behavior on a principal axis;
determine a current page scrolling direction according to the scrolling direction of a page on the principal axis;
determine a scrolling displacement amount of a page principal axis according to the principal axis displacement amount; and
send, to the server, the determined current page scrolling direction and the determined scrolling displacement amount of the page principal axis, so that the server scrolls a currently displayed page according to the current page scrolling direction and the scrolling displacement amount of the page principal axis.

18. The apparatus according to claim 12, wherein the non-transitory computer readable medium further has stored thereon instructions, that when executed, cause the processor to:
determine a current page scrolling direction according to a principal axis displacement amount and an auxiliary axis displacement amount, wherein the auxiliary axis is a longitudinal axis or a lateral axis of the touchscreen, and is different from a principal axis;
determine, in response to determining that the current page scrolling direction is on the principal axis, a scrolling displacement amount of a page principal axis according to the principal axis displacement amount;
determine, in response to determining that the current page scrolling direction is on the auxiliary axis, a scrolling displacement amount of a page auxiliary axis according to the auxiliary axis displacement amount;
determine, in response to determining that the current page scrolling direction is neither on the principal axis nor on the auxiliary axis, the scrolling displacement amount of the page principal axis according to the principal axis displacement amount, and determine the scrolling displacement amount of the page auxiliary axis according to the auxiliary axis displacement amount; and
send the scrolling direction of the page on the principal axis and the scrolling displacement amount of the page principal axis to the server, so that the server scrolls a currently displayed page according to the scrolling direction of the page on the principal axis and the scrolling displacement amount of the page principal axis;
send the scrolling direction of the page on the auxiliary axis and the scrolling displacement amount of the page auxiliary axis to the server, so that the server scrolls the currently displayed page according to the scrolling direction of the page on the auxiliary axis and the scrolling displacement amount of the page auxiliary axis; and
send a scrolling direction of the page on the principal axis, the scrolling displacement amount of the page principal axis, a scrolling direction on the auxiliary axis, and the scrolling displacement amount of the page auxiliary axis to the server, so that the server scrolls the currently displayed page according to the scrolling direction of the page on the principal axis, the scrolling displacement amount of the page principal axis, the scrolling direction on the auxiliary axis, and the scrolling displacement amount of the page auxiliary axis.

19. The apparatus according to claim 18, wherein the instructions causing the processor to determine a current page scrolling direction according to the principal axis displacement amount and an auxiliary axis displacement amount comprise instructions, that when executed, cause the processor to:
determine that the page scrolls in a direction of the auxiliary axis when a ratio of the principal axis displacement amount to the auxiliary axis displacement amount is less than a first direction threshold;
determine that the page scrolls in a direction of the principal axis when the ratio of the principal axis displacement amount to the auxiliary axis displacement amount is greater than a second direction threshold; and
determine that the current page scrolling direction is neither on the principal axis nor on the auxiliary axis when the ratio of the principal axis displacement amount to the auxiliary axis displacement amount is neither greater than the second direction threshold nor less than the first direction threshold.

20. The apparatus according to claim 12, wherein the non-transitory computer readable medium further has stored thereon instructions, that when executed, cause the processor to:
acquire a scrolling direction of the page on the principal axis;
determine a page flipping direction according to the scrolling direction of the page on a principal axis; and
send the determined page flipping direction to the server, so that the server adjusts a currently displayed page according to the page flipping direction.

21. The apparatus according to claim 12, wherein the non-transitory computer readable medium further has stored thereon instructions, that when executed, cause the processor to:
send scroll bar position request information to the server;
receive a server scroll bar position that is sent by the server in response to the scroll bar position request information;
display a scroll bar of a preset specification on the touchscreen according to a current server scroll bar position;
acquire a scroll bar displacement amount and a scroll bar displacement direction that are generated when the user uses the scroll bar of a preset specification; and
send, to the server, the scroll bar displacement amount and the direction that are generated when the user uses the scroll bar of a preset specification and are acquired by the acquiring module, so that the server adjusts a currently displayed page and the server scroll bar position according to the scroll bar displacement amount and the direction that are generated when the user uses the scroll bar of a preset specification.

22. The apparatus according to claim 12, wherein the non-transitory computer readable medium further has stored thereon instructions, that when executed, cause the processor to:
configured to display a preset function key on the touchscreen, wherein the preset function key comprises a Page Up key, a Page Down key, or both the Page Up key and the Page Down key; and
send, in response to detecting that a user taps the preset function key, a notification message corresponding to the preset function key tapped by the user to the server, so that the server adjusts a currently displayed page according to the notification message corresponding to the preset function key tapped by the user.
